(19) United States
(12) Patent Application Publication
(10) Pub. No.: US 2014/0247457 A1
(43) Pub. Date: Sep. 4, 2014

(54) System and Method of Creating A One-Way See-Through Shelf Set Presentation of Products

(71) Applicant: E&J Gallo Winery, Modesto, CA (US)

(72) Inventor: Patrick Gorman, New York, NY (US)

(73) Assignee: E&J Gallo Winery, Modesto, CA (US)

(21) Appl. No.: 14/198,478

(22) Filed: Mar. 5, 2014

Related U.S. Application Data
(62) Division of application No. 12/913,645, filed on Oct. 27, 2010.
(60) Provisional application No. 61/324,598, filed on Apr. 15, 2010.

(51) Int. Cl. G06K 15/02; H04N 1/393

(52) U.S. Cl. CPC G06K 15/023; H04N 1/3935; G06K 15/1852; G06K 15/02
USPC 358/1.2; 358/1.18

(57) ABSTRACT

A system and method of creating a one-way see-through shelf set presentation of products is disclosed. According to one embodiment, a computer-implemented method includes receiving product identification numbers that correspond to a plurality of products and retrieving price and image data for each of the plurality of products from a data storage unit based the received product identification numbers. The computer-implemented method also includes generating from the retrieved price and image data a printable image of a shelf set that depicts the plurality of products.

### RELATED APPLICATIONS

This is a divisional application of U.S. patent application Ser. No. 12/913,645, which claims priority to U.S. Provisional Application No. 61/324,598 that was filed on Apr. 15, 2010 and is incorporated by reference herein.

### RELATED FIELD

The present invention relates generally to systems, methods, and processes for managing retail space. More particularly, the present invention relates to a one-way see-through shelf set presentation for convenience stores.

### BACKGROUND

Many convenience liquor stores and shops in high crime urban areas are compelled to protect their employees and their expensive beverage stock. One common way to do this is to set up a protective barrier between the shopper and the shop employee. In this manner, the employee is in the secure area. Normally, the employee only not the consumer, has direct access to the products on the shelf.

The protective barrier that is utilized in high crime neighborhoods creates an ineffective merchandizing vehicle in convenience liquor stores because of the physical separation of the consumer and the products. Unlike stores with several aisles that the consumer walks through to examine merchandise, the shelf space in convenience liquor stores is limited because there is typically only one displayable shelf row. The shelves play the dual role of displaying the products available for sale and holding readily available inventory for sale to the consumer. Currently, with the highly restricted shelf space, these retailers must balance the tradeoff between selection and restocking efficiency and cost.

Selection comes at the retailer's increased labor expense associated with having to restock less than full case quantities at a time for his fast moving SKUs. Due to his limited shelf space, the retailer is not able to offer an optimal product selection. This requires him to make a trade-off between shelf facings for selection and shelf facings for readily available inventory. Inventory not readily available is stored as back room inventory. When a facing needs to be restocked, the inventory must be retrieved from the stock room. Because typical shelves in a secure area of the convenience store are not deep enough to hold case quantities with a single facing, SKUs are restocked with less than full case quantities. When a facing is restocked with less than full case quantities, this dramatically increases the labor costs because of the need to handle individual bottles and cases multiple times.

In addition, because the shelves are behind the protective barrier, counter, and the retailer's employees, the visibility of some or all of the selection is obstructed from certain angles and locations. Furthermore, the distance from the consumer often makes it difficult to see pricing and to see brand specific descriptions.

### SUMMARY

A system and method of creating a one-way see-through shelf set presentation of products is disclosed. According to one embodiment, a computer-implemented method includes receiving product identification numbers that correspond to a plurality of products and retrieving price and image data for each of the plurality of products from a data storage unit based the received product identification numbers. The computer-implemented method also includes generating from the retrieved price and image data a printable image of a shelf set that depicts the plurality of products.

The above and other preferred features, including various novel details of implementation and combination of elements, will now be more particularly described with reference to the accompanying drawings and pointed out in the claims. It will be understood that the particular methods and implementations described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles of the present invention.

FIG. 1 illustrates an exemplary layout of a convenience store, according to one embodiment.

FIG. 2 illustrates an exemplary material used for printing the shelf-set image, according to one embodiment.

FIG. 3 illustrates an exemplary one-way see-through shelf-set, according to one embodiment.

FIG. 4 illustrates an exemplary computer system for a convenience store, according to one embodiment.

FIG. 5 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAIL DESCRIPTION

A one-way see-through shelf set presentation for convenience stores is disclosed. According to one embodiment, an apparatus comprises a sheet of plexiglass separating a secure area and an unsecure area in a convenience store. The apparatus further comprises a vinyl film having perforations and having a shelf set image printed on the vinyl film, wherein the vinyl film is attached to the sheet of plexiglass. The vinyl film can be attached using an adhesive. It can also be attached without an adhesive using an attachment material such as static cling film.

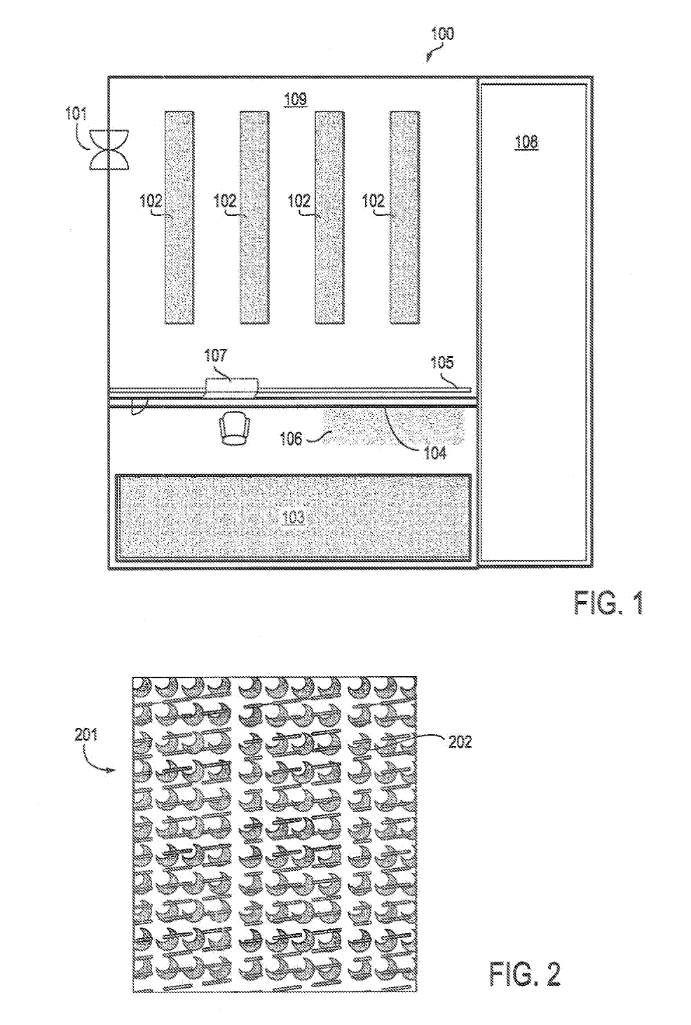

FIG. 1 illustrates an exemplary layout of a convenience store (100), according to one embodiment. A shopper coming in through the entrance door (101) enters a non-secure area (109). There may be shelves (102) that are stacked with various items including non-alcoholic beverages. However, the alcoholic beverages and liquors are kept in the secure area (106) behind a protective barrier (104). The protective barrier (104) is usually made of Plexiglas™. The employee works in the secure area (106). The employee stocks the shelves (103) from inventory within the storage room (108) that has a door to the secure area (106).

A shopper who wants to buy liquor approaches the security window (107). The shopper may look at the images of the available items for sale on a one-way see-through shelf-set image (105) that is adhered on the security barrier (104). The images of the items may match the items that are displayed on the wall shelf (103) in the secure area (106). The shopper may choose an item. The shopper may then tell the employee what that item is. The shopper then pays for the item through the security window (107). The employee passes the item to the shopper through the security window (107).

FIG. 2 illustrates an exemplary material used for printing the shelf-set image (105), according to one embodiment. The material is a perforated vinyl film (201). According to one embodiment, the image is printed on the vinyl film (201) and then adhered to the protective barrier (104).

The vinyl film (201) has small perforations or holes (202). According to one embodiment, vinyl film (201) may be 50% perforated. The holes (202) do not distort the image that is printed on the vinyl film. However, the holes (202) allow the employee to maintain visibility from the inside of the secure area (106).

Vinyl film (201) may be produced by various manufacturers. For example 3M™ has manufactures two vinyl films, namely “IJ8171 Perforated Window Graphic Film,” and “IJ66 Promotional Perforated Window Film.” Another manufacturer is 2e™ that manufactures a vinyl film named “2e Perforated Window Film.” Yet another manufacturer is ClearFocus™ that offers two vinyl films named “ClassicVue 6250 Perforated Window Film,” and “ImageVue 6350 Perforated Window Film.” Yet another manufacturer is CATALINA™ that makes “SP/CLEAR-AD Low Tack Window Film,” and “SP/SIGN-AD Low Tack Window Film.”

According to one embodiment, the printed vinyl film (201) may be protected from environmental factors such as collection of dust, water and dirt in the perforated areas (202) by applying an over-laminate product to the printed vinyl film (105). There are various over-laminating products. For example, 3M™ makes “Scotchcal 8914 Window Film Overlaminate.” Another manufacturer is ClearFocus™ that makes “ClearLam 6201 Window Film Overlaminate,” and “CurvaLam High Performance Window Film Overlaminate.”

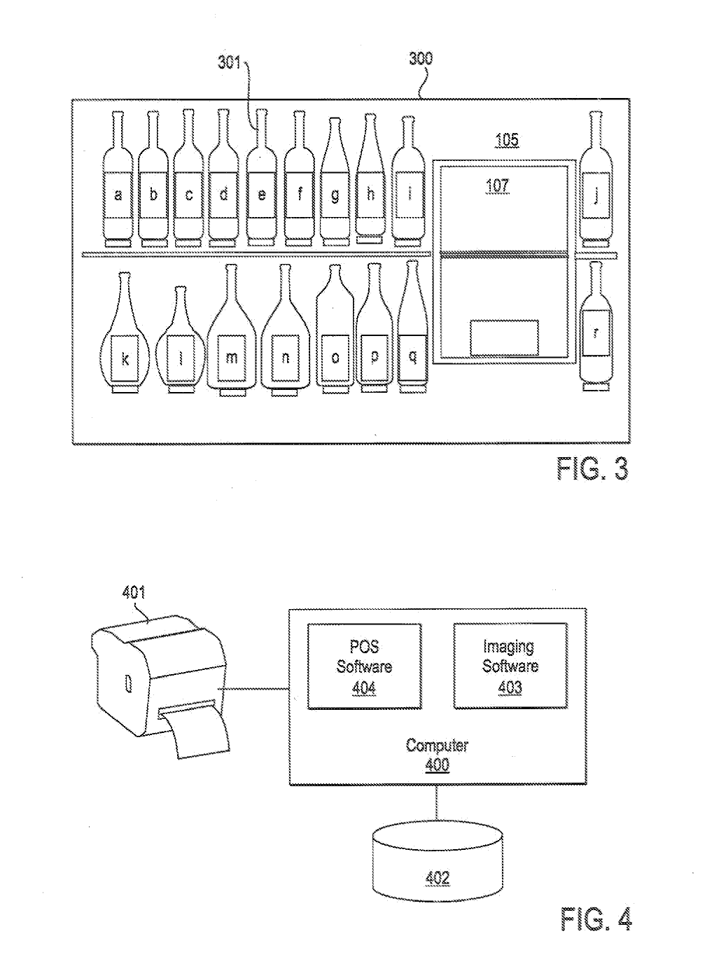

FIG. 3 illustrates an exemplary one-way see-through shelf-set (300), according to one embodiment. The images (301a-r) of items in the shelf-set (300) are arranged to construct one large image of the shelf-set. This image is then printed on the vinyl film (201) to create the shelf-set (300). The shelf-set (300) is then adhered to the protective barrier (104). Shelf-set (300) may have a window cutout for the security window (107).

According to another embodiment, each image (301a-r) of the items is printed on the vinyl film (201). The images of the items (301a-r) are cut out individually. These cutout images of items (301a-r) are then arranged manually and put on the protective barrier (104) to make the shelf-set (300). In general, the security window (107) is not covered.

From time to time, the employee may need to remove the shelf-set (300) from the protective barrier (104) to replace it with an updated one. According to one embodiment, the whole shelf-set (300) is removed from the protective barrier (104) and replaced by a new shelf-set image. According to another embodiment, individual images (301a-r) are removed. The images (301a-r) are cutouts that are rearranged or replaced. The cutouts of images (301a-r) are then adhered to the protective barrier (104).

Removing the vinyl film (201) may be achieved by peeling off the vinyl film (201) by hand from the protective barrier (104). If the vinyl film (201) has been in place for a while, it may get stuck to the protective barrier (104). In this case, a hair dryer may be used to warm up the vinyl film (201). A razor blade may be used to peel back the edge of the vinyl film (201). Once the edge of the vinyl film (201) is pulled back, the rest of the vinyl film may be pulled off by hand. If there is a small amount of adhesive residue remained on the protective barrier (104), a mix of soap and water may be used to remove it. For larger amounts of residue, Goof Off™ and denatured alcohol may be used to clean up the protective barrier (104).

FIG. 4 illustrates an exemplary computer system for a convenience store, according to one embodiment. This setup includes a computer (400), imaging software (403), point-of-sale (POS) software (404), database (402) and a printer (401). According to one embodiment, the imaging software (403) is utilized to construct a large image (300) that simulates the desired shelf-set. The shelf-set image (300) is printed on printer (401). According to another embodiment, each image (301a-r) is printed individually on printer (401) and then cut out.

The database (402) may store the POS software (404) data such as SKUs and pricing information for each item in the store's inventory. The SKUs and prices are extracted from the database (402). According to one embodiment, the SKUs, the pricing, and the images of the items (301a-r) are provided to the imaging software (403). The imaging software (403) is then used to construct the shelf-set image (300) for printing. Examples of the imaging software (403) may be Adobe™ Illustrator or Corel™ Draw.

According to another embodiment, the POS software (404) and the imaging software (403) may share the database (402). In this case, the SKUs, the prices and the item images (301a-r) are extracted from the database (402) into the imaging software (403). The imaging software (403) is then used to construct the shelf-set image (300) for printing. An examples of the imaging software (403) that can share the database with the POS software (404) is SmartDraw™.

There may be large convenience stores that utilize an integrated software suite. The software suite keeps track of the store's sales as well as providing functionality for store space management, shelf space management and imaging. The software suite may generally include modules for POS software, database and imaging software. According to another embodiment, the SKUs, the prices and the item images (301a-r) are extracted from the software suite's database module (402) into the software suite's imaging software module (403). The imaging software module (403) is then used to construct the shelf-set image (300) for printing. Examples of such software suites are Aldata Apollo and JDA Intactix.

The imaging software (403), the POS software (404) and the database (402) may all run on the same computer (400). According to one embodiment, the computer (400) may be a personal computer running under Microsoft™ Windows™

Printing on the vinyl film (201) requires a large format Piezo Ink Jet printer. According to one embodiment, the printer (401) could be of type Epson™ Stylus Pro Large-Format Printer (either 11880 or 9880). According to another embodiment, the printer (401) may be a Hewlett Packard™ DesignJet Z6100.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

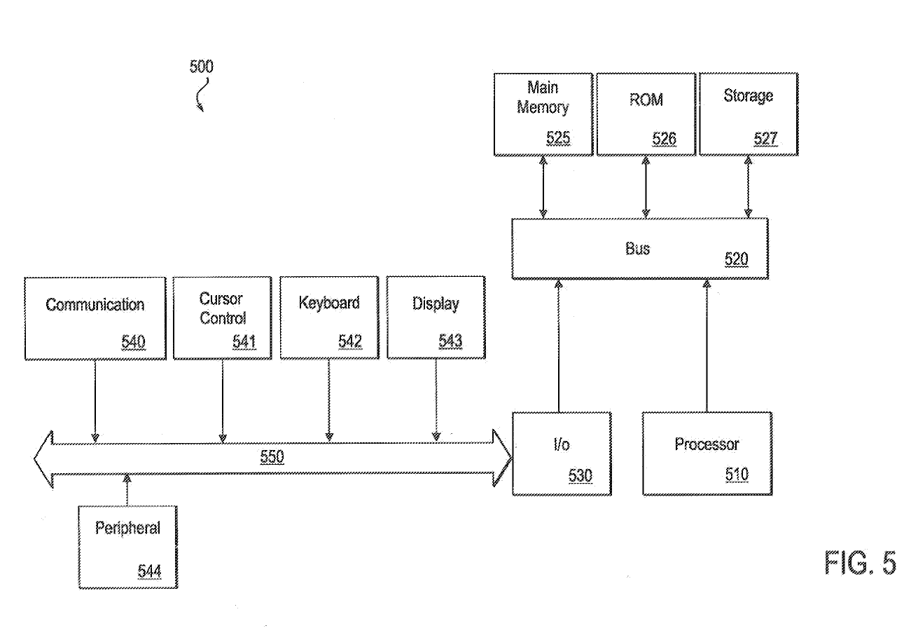

FIG. 5 illustrates an exemplary computer architecture for use with the present system, according to one embodiment. One embodiment of architecture (500) comprises a system bus (520) for communicating information, and a processor (510) coupled to bus (520) for processing information. Architecture (500) further comprises a random access memory (RAM) or other dynamic storage device (525) (referred to herein as main memory), coupled to bus (520) for storing information and instructions to be executed by processor (510). Main memory (525) also may be used for storing temporary variables or other intermediate information during execution of instructions by processor (510). Architecture (500) also may include a read only memory (ROM) and/or other static storage device (526) coupled to bus (520) for storing static information and instructions used by processor (510).

A data storage device (525) such as a magnetic disk or optical disc and its corresponding drive may also be coupled to computer system (500) for storing information and instructions. Architecture (500) can also be coupled to a second I/O bus (550) via an I/O interface (530). A plurality of I/O devices may be coupled to I/O bus (550), including a display device (543), an input device (e.g., an alphanumeric input device (542) and/or a cursor control device (541)).

The communication device (540) allows for access to other computers (servers or clients) via a network. The communication device (540) may comprise one or more modems, network interface cards, wireless network interfaces or other well-known interface devices, such as those used for coupling to Ethernet, token ring, or other types of networks.

A one-way see-through shelf set presentation for convenience stores is disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

1. A computer-implemented method, comprising:
receiving product identification numbers that correspond to a plurality of products;
retrieving price and image data for each of the plurality of products from a database based the received product identification numbers; and
generating from the price and image data a printable image of a shelf set that depicts the plurality of products.

2. The computer-implemented method of claim 1, further comprising: printing the printable image on perforated vinyl film.

3. The computer-implemented method of claim 1, wherein generating the printable image includes: generating a plurality of printable images from the price and image data; and printing the plurality of printable images on perforated vinyl film.

4. The computer-implemented method of claim 1, wherein generating a printable image further comprises: manipulating the size of the printable image to specific dimensions.

5. The computer-implemented method of claim 1, further comprising: generating a mirror image of the printable image.

6. The computer-implemented method of claim 5, further comprising: printing the mirror image on a non-adhesive side of a perforated clear vinyl film.

7. The computer-implemented method of claim 1, further comprising printing the shelf set as a plurality of separate images on the vinyl film.

8. The computer-implemented method of claim 7, wherein the plurality of separate images are shuffled and arranged to compose the shelf set.

9. A computer system, comprising:
a database configured to store price and image data for each of a plurality of products in a store's inventory;
an input module configured to receive product identification numbers that correspond to a subset of the plurality of products; and
an imaging module configured to generate a printable image of a shelf set that depicts the subset of the plurality of products.

10. The computer system of claim 9, further comprising: a printing module configured to print the printable image on perforated vinyl film.

11. The computer system of claim 9, wherein the image module is further configured to generate a plurality of printable images from the price and image data and print the plurality of printable images on perforated vinyl film.

12. The computer system of claim 9, wherein the image module is further configured to manipulate the size of the printable image to specific dimensions.

13. The computer system of claim 9, wherein the image module is further configured to generate a mirror image of the printable image.

14. The computer system of claim 13, further comprising: a printing module configured to print the mirror image on a non-adhesive side of a perforated clear vinyl film.

15. The computer system of claim 9, wherein the image module is further configured to print the shelf set as a plurality of separate images on the vinyl film.

16. The computer system of claim 15, wherein the plurality of separate images are shuffled and arranged to compose the shelf set.
